(19) United States
(12) Patent Application Publication
(10) Pub. No.: US 2009/0260573 A1
(43) Pub. Date: Oct. 22, 2009

(54) Portable Milking Apparatus and Method

(76) Inventor: Chad Rucks, Okeechobee, FL (US)

Correspondence Address: EMERGING STRATEGIES, LLP, 7416 LYNNHURST STREET, CHEVY CHASE, MD, 20815-3102, US

(21) Appl. No.: 12/104,574

(22) Filed: Apr. 17, 2008

(51) Int. Cl. A01J 5/003

(52) U.S. Cl. 119/14.02; 119/14.04

(57) ABSTRACT

A portable milking apparatus configured according to principles of the invention includes a platform configured to maintain an animal and an elevator that positions the platform in at least a lowered position, wherein the platform is generally aligned with the ground, and a raised position that enables milking at an ergonomically optimal height. A portable milking method includes elevating the animal sufficiently to enable milking at an ergonomically optimal height, wherein the elevating excludes inclined traversing.

### BACKGROUND OF THE INVENTION

The invention relates to a portable apparatus for and a method of milking cows that range free in a pasture.

Cows generally are milked twice a day. The manual work involved in milking is difficult and problematic from an ergonomic point of view. To reduce the risk of spinal issues that commonly arise from having to bend down to attach and remove the milking apparatuses, some dairy operations raise the animal to be milked relative to the dairy hands. However, such has been accomplished by means of ramps, as in U.S. Pat. No. 3,828,733, issued Aug. 13, 1974 to Correia for a Portable Milking Stall. However, hoofed animals are reluctant to ascend inclines and may suffer debilitating or fatal injuries while descending. Some inventions have resolved this with cars drawn up an inclined surface, as in U.S. Pat. No. 7,055,458, issued Jun. 6, 2006 to Guo for System for the Presentation of Animals to Be Milked and Method. However, such systems are not realistically feasible or economical.

What is needed is a portable milking apparatus and method that promote ergonomically-facile milking without having the animal ascend or descend a ramp or steps.

Research has shown that it is possible to increase the milk production from cows by 15-25% by milking three or even four times per day and this without detriment to the cows. Such benefits also may be found in other dairy animals, such as goats. However, the logistics and increased labor costs from herding the animals to a centralized milking facility limits profitable realization of this additional production.

Also, repeatedly congregating animals in one area for extended periods for milking causes a number of problems, including waste buildup. Dairy operations with permanent centralized milking facilities must clean the facilities and surroundings regularly to prevent the animals and dairy hands from becoming ill from waste-borne pathogens. Cleaning typically involves significant amounts of water drawn from an aquifer. The water combines with the waste and flows into manmade and natural waterways.

Another issue with centralized milking is that cows' repeated trampling kills grass and other vegetation en route to and around the milking facility. The reduced grazing space naturally discourages feeding cows from the denuded paths and promotes increased usage of spaces that gradually shrink as grazing thereon intensifies. As a consequence, the grazeable spaces experience increasingly higher nutrient loading, but as nutrient uptake by the grass is limited, more nutrients are brought into the local watershed basin.

While the trampled, hard-packed surrounding earth may be problematic, even more so are the concrete floors on which animals walk in centralized milking facilities. The hard concrete often causes hoof injuries over the long periods of time that the animals mill about the facilities. The concrete also can be slippery as it worn down and buffed with the detritus typical to the facilities, which causes the animals to fall and injure themselves, sometimes fatally.

In addition to the overgrazing that occurs, dairies with centralized milking facilities often harvest grass from other portions of the farm to provide to the cows while milking. Supplementary feed also may be purchased and brought to the facility. Both food supplying activities expend time and money, and typically involve burning carbon-based fuels by harvesting and transportation equipment that produces green house gases.

Another issue with denuded pastures is that animals thereon tend to accumulate fine-particulate mud and dust on their legs and udders. This undesirable residue, despite the best milking practices, increases the risk of mastitis, which is not healthy for the animal, and tends to wind up in the milk to some extent, which is not healthy for the public.

To counter these undesirable consequences, some dairies employ washing systems to wash off the animals before milking. The systems and operation thereof are expensive, time-consuming and expend a great deal of water that also must be recollected and disposed of.

In addition to environmental issues, centralized milking has significant economic considerations. First, permanent facilities are expensive to design and build. The expense can limit the natural expansion of a heard to what existing facilities can handle. Also, many dairy farmers lease the lands on which they raise their animals, so are reluctant to build what would be left behind after the lease ends.

What is needed is a portable milking apparatus and method that discourage the concentration of waste, thereby reducing the need for precious water resources and other consequences that remove nutrients.

### SUMMARY OF THE INVENTION

The invention overcomes the disadvantages noted above by providing a portable milking apparatus and method that promote ergonomically-facile milking without having the animal to be milked ascend or descend, and discourage the concentration of waste, thereby reducing the need for precious water resources and other consequences that remove nutrients.

To that end, an embodiment of a portable milking apparatus configured according to principles of the invention includes a platform configured to maintain an animal and an elevator that positions the platform in at least a lowered position, wherein the platform is generally aligned with the ground, and a raised position that enables milking at an ergonomically optimal height.

An embodiment of a portable milking method includes elevating the animal sufficiently to enable milking at an ergonomically optimal height, wherein the elevating excludes inclined traversing.

The invention provides for positioning animals and dairy personnel such that the milker does not need to bend down to apply the milking unit. The invention also provides that milking unit application can take place from behind the animals in any of parallel, parabone, herringbone or other arrangements. The invention allows dairy hands to approach closely to the animals for easy application and removal of the milking units.

An advantage of the invention is that, since the parlor is mobile, animals are not repeatedly congregated in a certain location, therefore animal waste does not have to be washed out of a centralized facility, which reduces the amount of water removed from an aquifer and nutrient rich water leaving the farm in the form of high nutrient run off, which can pollute nearby waterways.

Another advantage of the invention is that, since the parlor is mobile, animals are not repeatedly congregated in a certain location, therefore nutrients from the animals are dispersed all over a pasture without high concentrations in one area, which promotes higher uptake of nutrients by local vegetation.

A further advantage of the invention is that, since the parlor is mobile, animals are not repeatedly congregated in a certain location, therefore fewer denuded areas arise from where the grass and vegetation has been destroyed by animals repeatedly using the same pathways to the milking facility, which promotes higher uptake of nutrients by the vegetation and less nutrients brought into a watershed basin.

Yet another advantage of the invention is that animals are not subject to denuded areas, thus have less accumulation of mud and dust on their legs and udders, which reduces the risk of mastitis and promotes cleaner, healthier milk for the public, and eliminates the need for expensive pre-milking washing systems.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a front elevational view of an embodiment of a portable milking apparatus defining a lowered position configured according to principles of the invention;

FIG. 2 is front elevational view of the embodiment of FIG. 1 defining a raised position;

FIG. 3 is a right side elevational view of the embodiment of FIG. 1;

FIG. 4 is a right side elevational view of the embodiment of FIG. 2;

FIG. 5 is a partial cross-sectional detail view, drawn to an enlarged scale, of a portion of the embodiment of FIG. 1;

FIG. 6 is a partial cross-sectional detail view, drawn to an enlarged scale, of a portion of the embodiment of FIG. 2;

FIG. 7 is a side elevational view of another embodiment of a portable milking apparatus defining a lowered position configured according to principles of the invention; and

FIG. 8 is side view of the embodiment of FIG. 7 defining a raised position.

### DETAILED DESCRIPTION OF THE PREFERRED EMBODIMENTS

The invention is a portable milking apparatus that promotes ergonomically-facile milking without having the animal to be milked ascend or descend, and discourages the concentration of waste, thereby reducing the need for precious water resources and other consequences that remove nutrients.

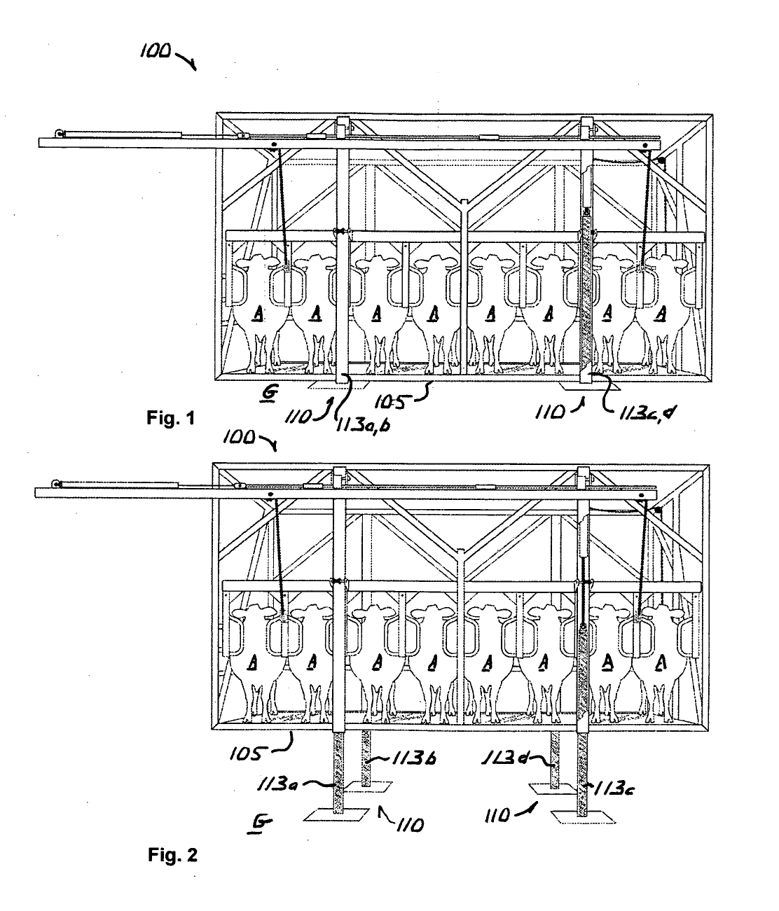

Referring to FIGS. 1-4, an embodiment of the portable milking apparatus 100 configured according to principles of the invention includes a platform 105 configured to maintain multiple dairy animals A and an elevator 110 that positions platform 105 in at least a lowered position, wherein the platform is generally aligned with the ground G as shown in FIG. 1, and a raised position that enables milking at an ergonomically optimal height, as shown in FIG. 2.

Platform 105 is configured and constructed of any material appropriate for maintaining an animal, such as a cow.

Elevator 110, preferably, includes extensible legs 113a-d as shown. The invention may employ other means for elevating platform 105.

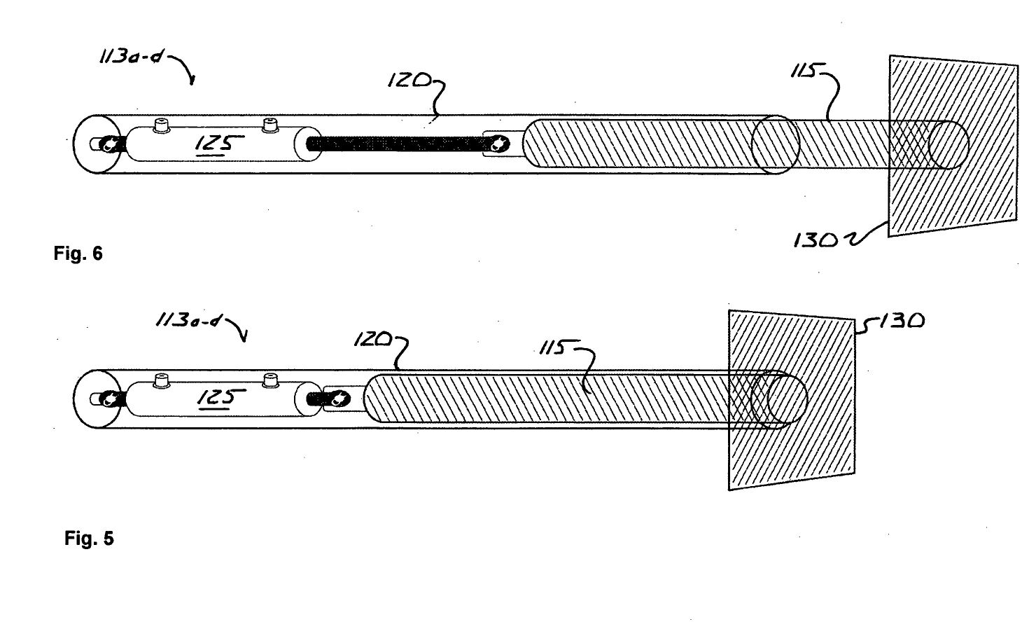

Referring also to FIGS. 5 and 6, each of legs 113a-d, preferably, includes a strut 115 received in a casing 120. Casing 120 is operably connected to platform 105. Strut 115 engages the ground G or field or pasture on which milking animals normally reside. A foot 130 may be interposed between strut 115 and ground G for increased stability.

A driver 125, such as a hydraulic, pneumatic or an electromagnetic cylinder, rack and pinion, jackscrew, or other means for extension and retraction of legs 100, is operably connected between strut 115 and casing 120 or platform 105 for effectuating relative movement, hence positioning of platform 105.

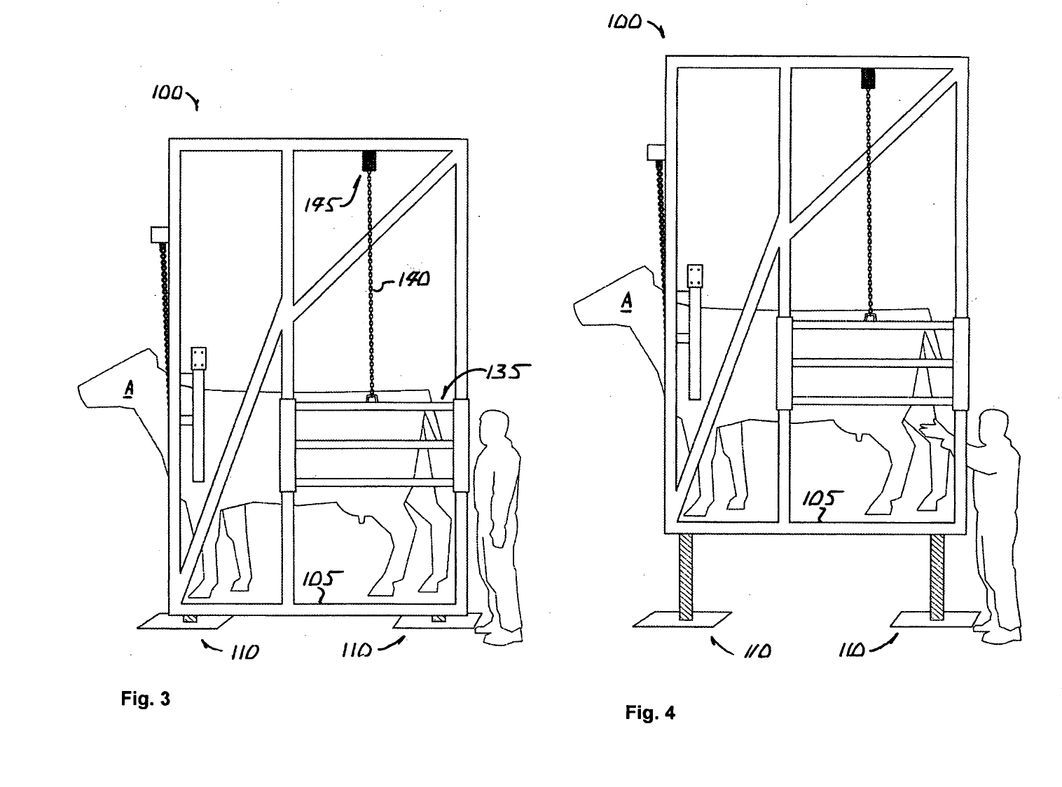

In operation, when platform 105 is in a lowered position, as shown in FIGS. 1 and 3, animal A may be led thereon without having to ascend a ramp or steps. Then, driver 125 extends legs 113 and elevates platform 105 into the raised position, as shown in FIGS. 2 and 4. On platform 105 in the raised position, animal A is at a height that allows a dairy hand to milk animal A without having to bend over to attach a milking apparatus (not shown). Once the milking procedure is complete, driver 125 returns platform 105 to the lowered position whereby animal A exits without having to descend a ramp or steps.

Referring to FIG. 3, apparatus 100 preferably includes a gate 135 for selectably receiving and retaining or excluding animals A. Gate 135 may be raised and lowered by a chain 140 that is manually or mechanically gathered and released through a pulley 145. The invention may employ other means for actuating gate 135, such as pneumatic, hydraulic or electromagnetic cylinders (not shown).

In operation, When gate 135 is in an up position, animals may enter onto platform 105. When gate 135 is in a down position (not shown), animals may not enter onto or leave platform 105.

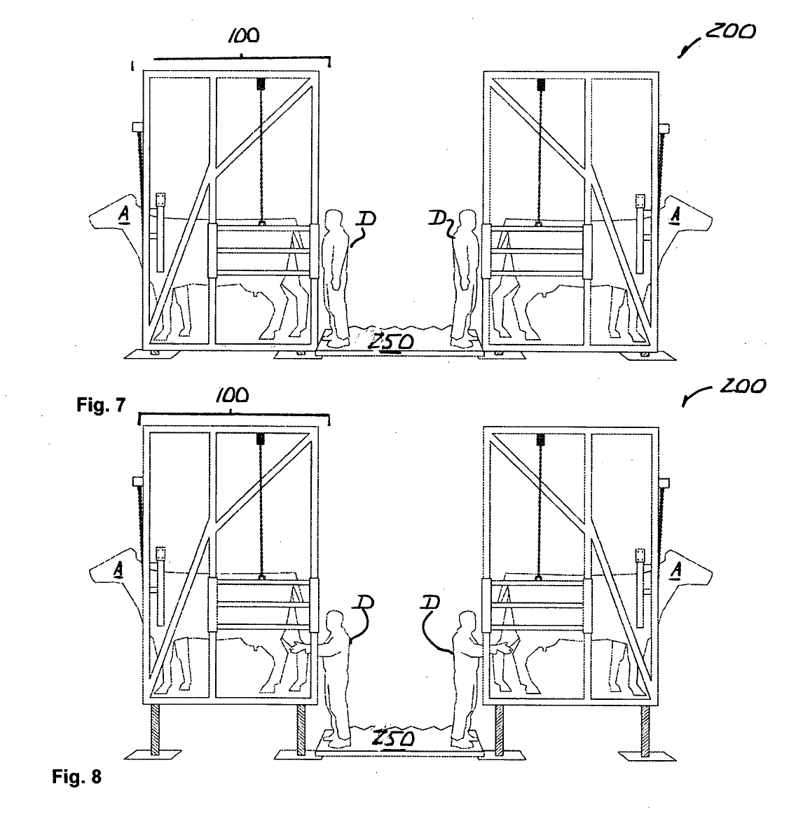

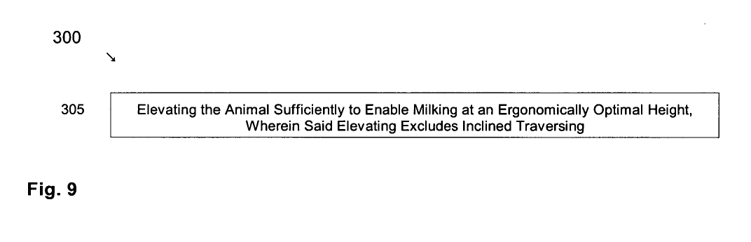

Referring to FIGS. 7 and 8, another embodiment of the portable milking apparatus 200 configured according to principles of the invention essentially multiple apparatuses 100 arranged as needed. Preferably, dairy hands D stand on a platform 250 positioned a few inches off of ground G while milking animal A. Although not shown above, platform 250 may be used with apparatus 100 as well.

Preferably, apparatuses 100 and 200 each include at least a wheel (not shown) rotatably mounted thereon, for example on foot 135, leg 110 or platform 105, or other means that promotes mobility of apparatus 100 so that apparatus 100 may be transported readily to wherever animals to be milked happen to be in the pasture. This mobility eliminates the issues associated with centralized milking facilities described above. Apparatuses 100 and 200 may be self-propelled or drawn to wherever it may be needed.

Referring to FIG. 9, an embodiment of a portable milking method 300 includes a step 305 of elevating the animal sufficiently to enable milking at an ergonomically optimal height. Step 305 excludes inclined traversing. In other words, as shown in FIGS. 1 and 3, animal A does not enter onto platform 105 by having to ascend a ramp or steps.

The invention is not limited to the particular embodiments described and depicted herein, rather only to the following claims.

1. Apparatus for milking an animal comprising:
a platform configured to maintain the animal; and
an elevator that positions said platform in at least a lowered position, wherein said platform is generally aligned with the ground, and a raised position that enables milking from the ground at an ergonomically optimal height.

2. Apparatus of claim 1, wherein a distance between said lowered position and said raised position is adjustable.

3. Apparatus of claim 1, further comprising a stall configured to retain the animal on said platform.

4. Apparatus of claim 1, further comprising a retractable gate configured to selectably retain the animal on said platform.

5. Apparatus of claim 1, further comprising a ground-engageable wheel rotatably mounted relative to said platform.

6. Apparatus of claim 1, wherein said elevator comprises a hydraulic or pneumatic cylinder, a rack and pinion, a jackscrew or combinations thereof.

7. Method of milking an animal comprising:
elevating the animal sufficiently to enable milking from the ground at an ergonomically optimal height;
wherein said elevating excludes inclined traversing.

8. Method of claim 7, further comprising, prior to said elevating, providing for ingress that is generally aligned with the ground.

9. Method of claim 7, further comprising, following said elevating:
milking the animal; and
lowering the animal.

10. Method of claim 9, further comprising, following said lowering, providing for egress that is generally aligned with the ground.

11. Method of claim 7, further comprising, prior to said elevating, going to the animal.
